(19) United States
(12) Patent Application Publication
(10) Pub. No.: US 2003/0018723 A1
(43) Pub. Date: Jan. 23, 2003

(54) System and method of managing a change in an electronic mail address

(76) Inventors: Lawrence G. Almeda, Rochester Hills, MI (US); Steven T. Morrow, Rochester, MI (US)

Correspondence Address: Lawrence G. Almeda, 2501 S. Christian Hills Drive, Rochester Hills, MI, 48309, US

(21) Appl. No.: 09/909,367

(22) Filed: Jul. 19, 2001

(51) Int. Cl. G06F 15/16

(52) U.S. Cl. 709/206; 709/245

(57) ABSTRACT

The present invention involves a method of managing an update of an old e-mail address to a new e-mail address of a first party via a first system, wherein the update is managed by a second system for a second party. The invention includes providing inputted information of the update in the first system and sending the inputted information to the second system. The inputted information represents the update and is recognizable by the second system. The method further includes configuring the information of the update into the second system to monitor outgoing email addresses of subsequent email messages and sensing an outgoing email address of a subsequent email message sent from the second system. The method further includes redirecting the subsequent email message to the new email address of the first client, if the outgoing email address is determined to be the old email address of the first client.

### CROSS-REFERENCE TO RELATED APPLICATIONS

This application is related to U. S. utility application filed on Jul. 19, 2001 having Ser. No. ______ and entitled “METHOD OF MANAGING AN UPDATE OF A CHANGED ELECTRONIC MAIL ADDRESS.”

### BACKGROUND OF THE INVENTION

1. Field of the Invention

The present invention relates to systems and methods of managing an update or a change of an old electronic mail (“email”) address to a new email address of a first client via a first system, wherein the update or change is completed by a second system for a second client.

2. Background Art

Today, the use of email is common practice. As known in the art, sending and receiving email may be performed by individuals via central processing units and respective associated monitors. Users of email range within a broad spectrum of ages involving different purposes. Today, email users as young as grade school students or younger have email access along with sufficient computer operational skills. Many grade school students use email for academic assignments as well as for entertainment and pleasure. High school and college students typically have email access and use email on a day-to-day basis for academic and personal purposes. Moreover, many members of the work force depend on email as a significant means of communication in business, being that email is an effective, non-intrusive means of communication between clients. Additionally, several email users implement email solely for personal use. Furthermore, even many elderly individuals have implemented the use of email as an easy form of communication.

As the use of email has grown to be a significant means of communication, the use of email obviously requires a correct email address of a receiving client to whom an email message is sent. Otherwise, the email message will be undeliverable and, thus, will not be received by the receiving client. Maintaining correct email addresses of different email users has in aggregate become relatively time consuming, since email user addresses are dynamic and continuously changing. For example, in the work force, individuals continue to change jobs for various reasons. In such events, business email addresses of such individuals will typically change, since different corporations/companies carry different email addresses for their respective employees. Additionally, as internet carrier/server rates continue to change, decrease, and/or provide increasingly improved service, email users will continue to shop around, find the best rates, and change internet carriers accordingly. Such change usually involves having the user add a new email address representing a new internet carrier/provider, and typically results in terminating a former email address representing an old internet carrier/provider. In many cases, after an interim, the former email address may be available to be used again as another user's email address.

Current means of making an email address change are adequate, but can be improved. For example, many email users update email addresses in their respective email address books by a method known as a “clip and paste” method. That is, via a central processing unit and an associated monitor, a correct email address is highlighted or blocked by use of a conventional computer mouse or touch pad, and “copied” in any suitable way as known in the art. Then, an email address book is opened which typically has a file associated with an old email address to be changed. Then, the correct or updated email address is “pasted” over the old email address to make the change in email address. The is relatively time consuming.

Other email users may update email addresses by more sophisticated means; however, such means require numerous steps or pull-downs of a number of software windows as known in order to make the update. Moreover, internet-based email systems provide adequate ways of updating an email address; however, such systems require numerous steps or separate web pages in order to make the update. These too are time consuming.

Current ways of managing an email address change have found challenged with limited success. In many situations, email users may chose to not regularly update or apply use an email address book. Typically, moderate users of email may not partake in updating an available email address book simply because their volume of email use is relatively low, defeating the practicality of an updated email address book. Such users may keep a written record of email addresses frequently used. Alternatively, such users may merely find a previous (sent or received) email message of a recipient client to whom the user desires to communicate, and access the email address of the recipient client using the “clip and paste” method. Moreover, such user may merely reply to a previously received email message from the recipient client.

However, in situations where the recipient client has changed his/her/it's email address to a new email address, the user typically receives a responding message notifying the user that the recipient's email address no longer exists and is undeliverable. In these situations, the user is faced with inconveniences in obtaining a new email address of the recipient client. For example, the user may be required to contact the recipient client by other means, such as telephone or written correspondence, just to obtain the new email address. The situation obviously becomes more significant wherein a time constraint is involved.

Currently, to lessen such inconveniences, the user must have the new email address of the recipient client. In some instances, the recipient client previously informs the user of the change and the user makes record of such change. On instances in which the user does not take note as to the change, the user may obtain the new email address from a saved email correspondence informing the user of the change, if the recipient client previously informed the user by email. However, managing an updated email address requires steps that both the recipient client and the user must take in order to continue communication with each other. Steps incorrectly taken results in increased time consumption and in decreased efficiency and productivity in most environments.

### SUMMARY OF THE INVENTION

Thus, it is an object of the present invention to provide an improved system and method of automatically managing a change from a previous email address to a new email address, wherein the system and method is time efficient.

It is another object of the present invention to provide an improved system and method of automatically making a change in an email address of a first client, wherein the email address is stored in an email address book of a second client.

It is yet another object of the present invention to provide a method of managing an update of an old email address to a new email address of a first client via a first system. The update is made by a second system for a second client. The method comprises providing inputted information of the update in the first system and sending the inputted information from the first system to the second system via a communication network. The inputted information represents the update of the old and new email addresses and identification of the first client. The inputted information is recognizable by the second system. The method further includes configuring the information of the update into the second system to monitor outgoing email addresses of subsequent email messages and sensing an outgoing email address of a subsequent email message sent from the second system. The method further includes redirecting the subsequent email message to the new email address of the first client, if the outgoing email address is determined to be the old email address of the first client.

It is still another object of the present invention to provide a method of making a change in an email address of a first client via a first system, wherein the change is made by a second system for a second client. The second system is associated with an email address database. The method comprises providing an inputted editing program configured within the first and second systems to edit a change of an old email address to a new email address of the first client within the email address database containing the old email address of the first client. The method further includes sending from the first system an editing file of the editing program to the second system via a communication network. The editing file is configured to receive inputted information of the change, wherein the editing file has inputted information representing the change of the old and new email addresses and identification of the first client. The information is recognizable by the second system. The method further comprises notifying the second client of the change via the second system and receiving authorization from the second client to edit the old email address in the email address database within the second system to the new email address. The method further includes editing the old email address in the email address database within the second system to the new email address.

It is yet another object of the present invention to provide an email managing system for managing an update of an old email address to a new email address of a first client via a first system, wherein the update is managed by a second system for a second client. The email managing system comprises a first mechanism for providing an inputted monitoring program configured within the first and second systems. The monitoring program is capable of monitoring outgoing email addresses of subsequent email messages. The email managing system further comprises a second mechanism for sending from the first system a monitoring file of the monitoring program to the second system via a communication network, wherein the monitoring file is configured to receive inputted information of the update. The monitoring file has inputted information representing the update of the old and new email addresses and identification of the first client, wherein the information is recognizable by the second system. The email managing system further comprises a third mechanism for configuring the information of the update into the monitoring program within the second system to monitor outgoing email addresses of subsequent email messages and a fourth mechanism for sensing an outgoing email address of a subsequent email message sent from the second system. The email managing system further includes a fifth mechanism for redirecting the The email managing system further includes a fifth mechanism for redirecting the subsequent email message to the new email address of the first client, if the outgoing email address is determined to be the old email address of the first client.

It is still another object of the present invention to provide an email update system for making a change in an email address of a first client via a first system, wherein the change is made by a second system for a second client. The second system is associated with an email address database. The email update system comprises a first mechanism for providing an inputted editing program configured within the first and second systems to edit a change of an old email address to a new email address of the first client within the email address database containing the old email address of the first client. The email update system further includes a second mechanism for sending from the first system an editing file of the editing program to the second system via a communication network. The editing file is configured to receive inputted information of the change, wherein the editing file has inputted information representing the change of the old and new email addresses and identification of the first client. The information is recognizable by the second system. The email update system further includes a third mechanism for notifying the second client of the change via the second system and a fourth mechanism for receiving authorization from the second client to edit the old email address in the email address database within the second system to the new email address. The email update system further includes a fifth mechanism for editing the old email address in the email address database within the second system to the new email address.

### BRIEF DESCRIPTION OF THE DRAWINGS

FIG. 1 is a schematic view of an embodiment of one system implemented in accordance with the present invention;

FIG. 2 is a flowchart depicting one embodiment of a method used with the system of FIG. 1 in accordance with the present invention;

FIG. 3 is flowchart depicting another embodiment of a method used in accordance with the present invention;

FIG. 4 is a schematic view of another embodiment of a system implemented in accordance with the present invention; and

FIG. 5 is a flowchart depicting one embodiment of a method used with the system of FIG. 4 in accordance with the present invention.

### DETAILED DESCRIPTION OF THE PREFERRED EMBODIMENT(S)

The present invention provides a simple, time efficient way for a client or an email user to update and/or manage a portfolio of email addresses within a database of a system associated with the email user.

In one embodiment, the present invention provides a solution in managing a change in an email address wherein a first client has an “old” email address and a “new” updated email address. By email, the first client via a first client's system informs a second client of the change. The present invention allows the second client via a second client's system to automatically configure the change within the second client's system and automatically monitor each email address of each subsequent outgoing email message to be sent by the second client via the second system. In this embodiment, as each outgoing email address is sensed, it is determined whether the outgoing email address is an “old” email address. If so, then the outgoing email message is redirected to the “new” updated email address of the first client. This prevents the second client from sending undeliverable email messages, and thus saves time and effort to the second client. Moreover, this embodiment provides that a plurality of email address changes involving several other different clients may be configured within the second client's system.

In another embodiment, the present invention provides a solution for a client to automatically make a change regarding another user's email address, wherein the user has an “old” email address and a “new” email address. Within the client's own system, the “old” email address is automatically edited to reflect the user's “new” email address. This change is done automatically without manual play by the client. Thus, this embodiment of the present invention allows the user via the user's system to send an editing file to the client's system, and upon authorization, automatically edit the email address database of the client's system for the client. This saves the client time in manually updating the email address database.

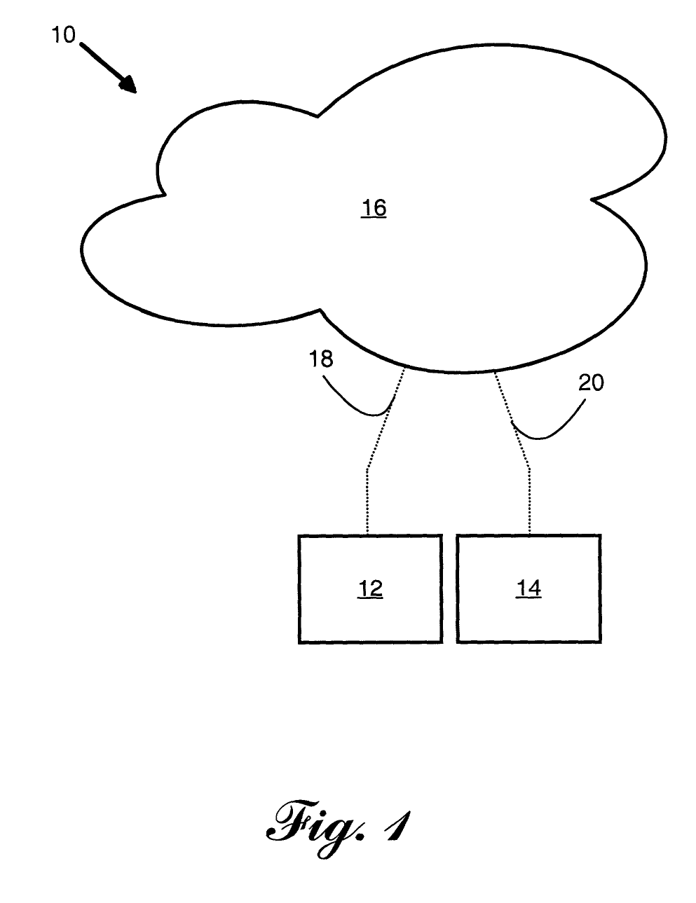

FIG. 1 schematically illustrates a computer implemented e-mail managing system 10 for managing an update of an old e-mail address to a new email address of a first client via a first system, wherein the update is managed by a second system for a second client. As shown, e-mail managing system 10 includes first system 12 associated with first server 13 and second system 14 associated with second server 15. First and second systems 12, 14 may be in communication with each other via communication network 16. First system 12 is in communication with communication network 16 by way of first communication means 18 and second system 14 is in communication with communication network 16 by way of second communication means 20. First and second communication means 18, 20 may be any suitable means for communicating first and second systems 12, 14 respectively to communication network 16. For example, as known in the art, communication means for communicating between systems via the Internet may include a modem connected by a phone line to operating regional servers. Moreover, first and second systems 12,14 each further include respective databases 22, 24.

First system 12 may be associated with a first client to whom first system provides Internet service. Second system 14 may be associated with a second client to whom second system 14 provides Internet service. In this embodiment, both the first and second clients are able to send and receive e-mail messages with first and second systems 12, 14, respectively, via communication network 16. For example, first system 12 and second system 14 may be separate Internet providers having respective Internet servers 13, 15, as known in the art, wherein communication network 16 represents the Internet. Of course, first and second systems 12, 14 may share the same server by which the first and the second clients receive and send e-mail messages. However, in this embodiment, it is to be noted that first and second systems 12, 14 have separate servers 13, 15 by which the first and second clients, respectively, communicate.

It is to be noted that the preferred embodiment of the present invention is implemented by at least a central processing unit (cpu) and a monitor. The monitor displays selection windows of a graphical user interface with which the user interacts by using a conventional mouse, touch pad, and/or keyboard. The keyboard, mouse, or touch pad may, in turn, is in communication with the central processing unit which is in communication with the computer monitor. As known in the art, the cpu may include a modem connected to a phone line which allows the cpu to communicate a remote server for Internet connection.

In this embodiment, communication network 16 represents the Internet, as known, by which e-mail messages may be sent and received between first and second systems 12, 14. Of course, communication network 16 may be a local network (LAM), a metropolitan area network (MAN), a wide area network (WAN), or any other area network available that provides an inter-connecting network which allows e-mail to be received and sent between first and second systems 12, 14. In this embodiment, first and second systems 12, 14 represents systems of Internet carriers/providers. Of course, systems 12, 14 may include systems of hard drives for central processing units, systems of local area networks, systems of metropolitan area networks, and systems of wide area networks. A client may be defined as a user of systems 12, 14. For example, the first client may be an Internet subscriber/user of first system 12 which is an Internet provider/carrier. In this embodiment, databases 22, 24 may be any suitable memory-storing means for storing information.

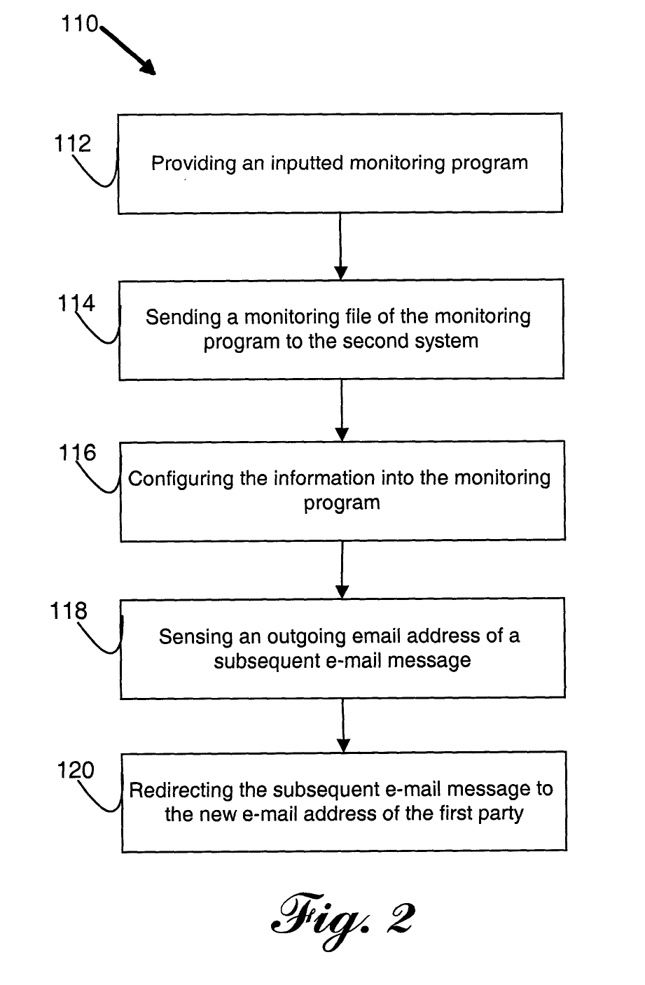

FIG. 2 illustrates a general method of the present invention in accordance with system 10 of FIG. 1 for managing an update of an old e-mail address to a new e-mail address of a first client via first system 12, wherein the update is managed by second system 14 for a second client. In an event in which the first client has an update from an “old” e-mail address to a “new” e-mail address, the first client may choose to inform the second client of such change. In this embodiment, the present invention allows the second client to receive and manage the update such that the second client's subsequent e-mail messages are not inadvertently sent to the first client's “old” e-mail address. Rather, the present invention assures that the second client sends subsequent e-mail messages correctly to the first client's “new” e-mail address.

The method as generally shown in reference 110 of FIG. 2 preferably but not necessarily includes providing inputted information of the update in first system 12 as shown in block 112. Method 110 further includes sending the inputted information from first system 12 to second system 14 via communication network 16 in block 114, wherein the inputted information represents the update of the old and new e-mail addresses and identification of the first client. The inputted information is recognizable by second system 14. The information of the update includes data indicative of the client. The information includes the old e-mail address of the first client, the new e-mail address of the first client, identification of the first client, effective date of the update, and time period of the update. The second system recognizes the information of the update.

Method 110 further includes configuring the information of the update into second system 14 to monitor outgoing e-mail address of subsequent email messages in block 116. Method 110 further includes sensing an outgoing email address of a subsequent e-mail message sent from second system 14 in block 118, and redirecting the subsequent e-mail message to the new e-mail address of first client 112, if the outgoing e-mail address is determined to be the old e-mail address of the first client in block 120.

It is to be noted that, in the preferred embodiment, a plurality of first clients may perform the method in accordance with the present invention. This allows the second client to manage a plurality of updates with the second system.

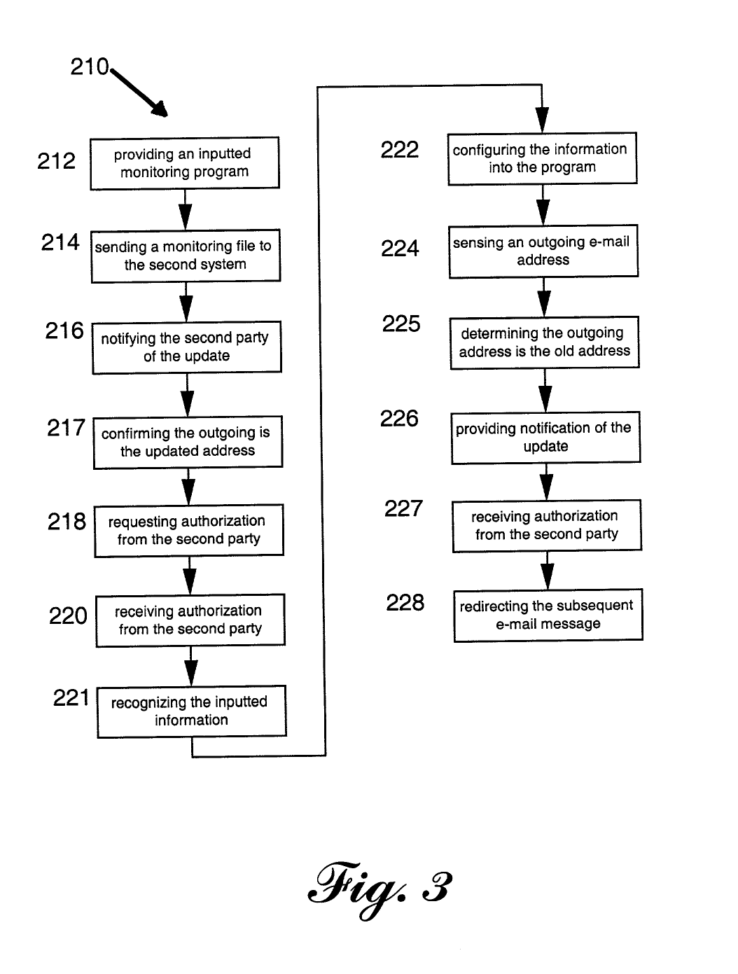

As shown, FIG. 3 illustrates an example of the general method of FIG. 2. In this embodiment, method 210 comprises a more specific methodology of steps of the present invention. Method 210 preferably but not necessarily comprises providing an inputted monitoring program configured within first and second systems 12, 14 in block 212, wherein the monitoring program is capable of monitoring outgoing e-mail addresses of subsequent e-mail messages. Then, method 210 includes sending from first system 12 a monitoring file of the monitoring program to second system 14 via communication network 16 in block 214, wherein the monitoring file is configured to receive inputted information of the update to be recognized by the monitoring program. The monitoring file has inputted information which represents the update of the old and new e-mail addresses and identification of the first client. The information is recognizable by the monitoring program of second system 14.

For example, upon realizing an e-mail address update, the first client may initially create a monitoring file of the monitoring program. The monitoring file may merely be a pull-down file of the monitoring program in which information is inputted to identify the update and the first client. The first client's “old” and “new” e-mail addresses may be required to be inputted along with the first client's name or identification. Of course, any suitable information may be used to identify the first client. In one embodiment, the file may be saved in database 13. Then, upon creating an e-mail message for the second client, the first client may attach the file to the message which is subsequently sent to the second client.

It is to be noted that the monitoring program may be any software program configured to recognize the inputted information from the monitoring file and to monitor outgoing e-mail addresses of subsequent e-mail messages sent from second system 14 based on the inputted information. Moreover, the monitoring file may be any file or directory of the monitoring program capable of receiving the inputted information such that the information may be recognized by the monitoring program.

After sending the monitoring file, method 210 includes notifying the second client via the second system of the update in block 216, confirming with the second client that the outgoing e-mail address is the updated e-mail address in block 217, and requesting authorization from the second client to configure the monitoring program within second system 14 with the new e-mail address in block 218. Then, method 210 includes receiving authorization from the second client to configure the monitoring program within the second system with the new e-mail address in block 220 and recognizing the inputted information in the monitoring file in block 221.

For example, upon opening the e-mail message from the first client, the second client may open the attached file of the monitoring program. When open, the file may provide a brief notice to the second client of the first client's email address update. This simply may be accomplished with a window stating information of the change. Moreover, the window may require the second client to confirm receipt of the notice by clicking a first icon. Then, the window may request authorization from the second client by requesting the second client to click a second icon. Thus, the second client may provide authorization to configure the monitoring program within second system 14 by clicking the second icon.

Moreover, method 210 further includes configuring the information of the update into the monitoring program within the second system to monitor outgoing e-mail addresses of subsequent e-mail messages in block 222, and sensing an outgoing e-mail address of a subsequent e-mail message sent from the second system in block 224. For example, upon receiving authorization from the second client, the monitoring program may be designed to open the monitoring file and access the inputted information. The program may then execute the information as parameters within which the program operates. In this embodiment, the program is configured to monitor all outgoing e-mail addresses of subsequent e-mail messages to be sent by the second client from second system 224.

Next, method 210 further includes determining whether the outgoing e-mail address is the old e-mail address of the first client in block 225, and providing notification of the update of the outgoing e-mail address to the second system in block 226, if the outgoing e-mail address is determined to be the old email address of the first client. For example, upon sensing an outgoing e-mail address, the monitoring program compares the outgoing e-mail address with the “old” e-mail addresses. If the outgoing e-mail address is the same as any one of the “old” e-mail addresses, then the monitoring program provides a notification via a notification window, informing the second client that the outgoing e-mail has been updated to the “new” e-mail address.

Moreover, method 210 includes receiving authorization from the second client to redirect the subsequent e-mail message to the new address when confirmation is given by the second client in block 227, and redirecting the subsequent e-mail message to the new e-mail address of the first client, if the outgoing e-mail address is determined to be the old e-mail address of the first client in block 228. For example, the notification window may include an authorization icon which when clicked by the second client confirms authorization, and automatically changes the address and redirect the subsequent e-mail message to the new” e-mail address.

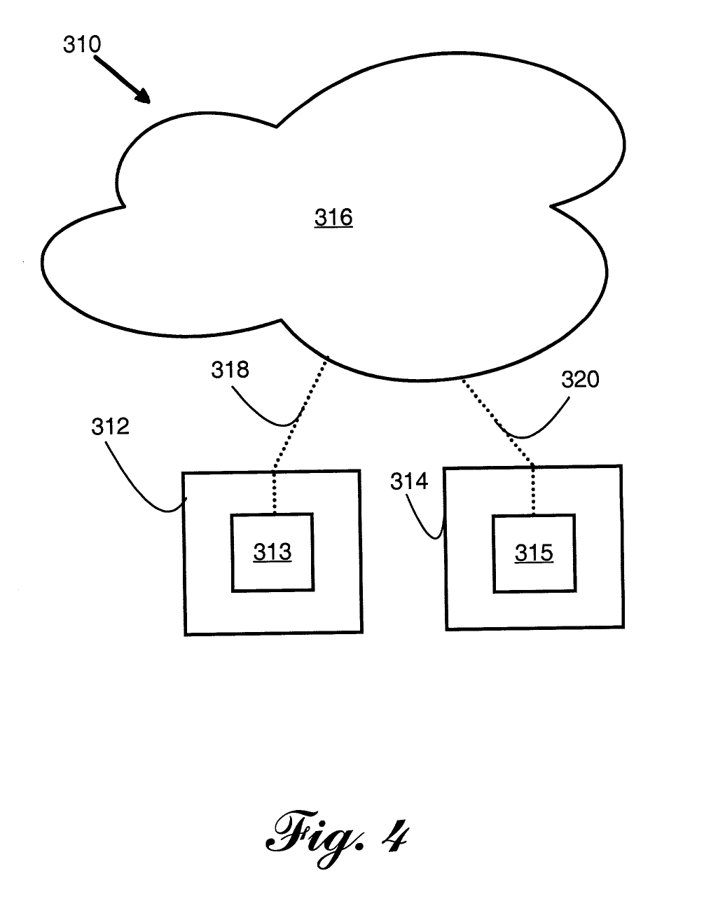

FIG. 4 schematically illustrates e-mail updating system 310 for making a change in an e-mail address of a first client via a first system 312, wherein the change is made by a second system 314 for a second client. First system 312 is associated with first e-mail address database 313 and second system 314 is associated with second e-mail address database 315. Moreover, first system 312 is associated with first server 322 and second system 314 is associated with second server 324. First and second systems 312, 314 may be in communication with each other via communication network 316. As shown, first system 312 is in communication with communication network 316 by way of first communication means 318. Second system 314 is in communication with communication network 316 by way of second communication means 320. First and second communication means 318, 320 may be any suitable means for communicating first and second systems 312, 314, respectively to communication network 316. For example, as known in the art, communication means for communicating between systems via the Internet may include a modem connected by a phone line to operating regional servers. Communication network 316 may be the same network as communication network 16 described in the embodiment above.

First system 312 may be associated with a first client to whom first system provides Internet service. Second system 314 may be associated with a second client to whom second system 314 provides Internet service. In this embodiment, both the first and second clients are able to send and receive e-mail messages with first and second systems 312, 314, respectively, via communication network 16. For example, first system 312 and second system 314 may be separate Internet providers having respective Internet servers 313, 315, as known in the art, wherein communication network 16 represents the Internet. Of course, first and second systems 312, 314 may share the same server by which the first and the second clients receive and send e-mail messages. However, in this embodiment, it is to be noted that first and second systems 312, 314 have separate servers 313, 315 by which the first and second clients, respectively, communicate.

It is to be noted that the preferred embodiment of the present invention is implemented by at least a central processing unit (cpu) and a monitor. The monitor displays selection windows of a graphical user interface with which the user interacts by using a conventional mouse, touch pad, and/or keyboard. The keyboard, mouse, or touch pad may, in turn, is in communication with the central processing unit which is in communication with the computer monitor. As known in the art, the cpu may include a modem connected to a phone line which allows the cpu to communicate a remote server for Internet connection.

In this embodiment, communication network 316 represents the Internet, as known, by which e-mail messages may be sent and received between first and second systems 312, 314. Of course, communication network 316 may be a local network (LAM), a metropolitan area network (MAN), a wide area network (WAN), or any other area network available that provides an inter-connecting network which allows e-mail to be received and sent between first and second systems 312, 314. In this embodiment, first and second systems 312, 314 represents systems of Internet carriers/providers. Of course, systems 312, 314 may include systems of hard drives for central processing units, systems of local area networks, systems of metropolitan area networks, and systems of wide area networks. A client may be defined as a user of systems 312, 314. For example, the first client may be an Internet subscriber/user of first system 312 which is an Internet provider/carrier. In this embodiment, databases 313, 315 may be any suitable memory-storing means for storing information.

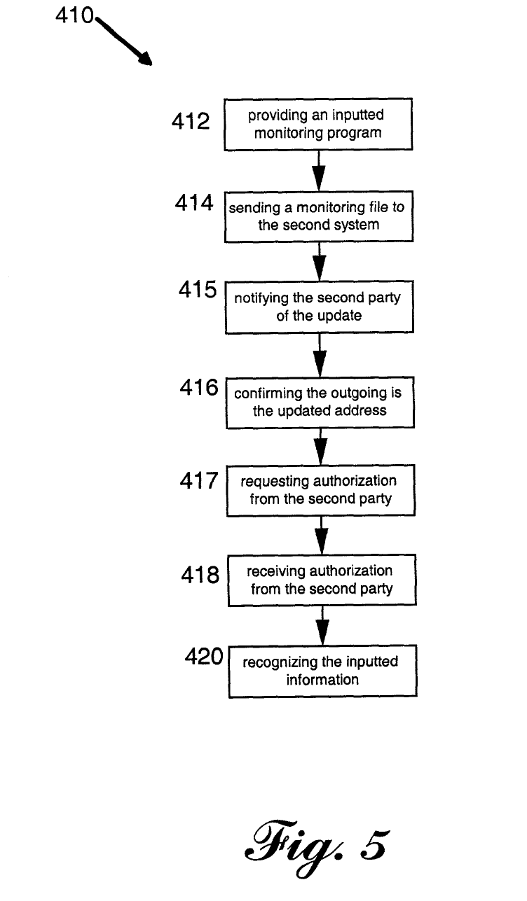

FIG. 5 illustrates method 410 of making the change in an e-mail address of a first client via first system 312, wherein the change is made by second system 314 for a second client. Method 410 comprises providing an inputted editing program which is configured within first and second systems 312, 314 to edit a change of the first client's old e-mail address to a new e-mail address within second database 315 which contained the old e-mail address of the first client in block 412. Then, method 410 further includes sending from first system 312 an editing file of the editing program to second system 314 via communication network 316 in block 414. The editing file is configured to receive inputted information of the change, wherein the editing file has inputted information representing the change of the old and new e-mail addresses and identification of the first client. The information of the change includes data indicative of the first client. The information includes the old e-mail address of the first client, the new e-mail address of the first client, identification of the first client, effective date of change, and time period of change. The information is recognizable by second system 314.

For example, upon realizing an email address update, the first client may initially create an editing file of the editing program. The editing file may merely be a pull-down file of the editing program in which information is inputted to identify the update and the first client. The first client's “old” and “new” e-mail addresses may be required to be inputted along with the first client's name or identification. Of course, any suitable information may be used to identify the first client. In one embodiment, the file may be saved in database 313. Then, upon creating an e-mail message for the second client, the first client may attach the file to the message which is subsequently sent to the second client.

It is to be noted that the editing program may be any software program configured within first and second systems to edit a change of the first client's old e-mail address to a new e-mail address within a second database which contained the old e-mail address of the first client. Moreover, the editing file may be any file or directory of the monitoring program capable of receiving the inputted information such that the information may be recognized by the editing program.

Method 410 further includes recognizing the inputted information in the sent editing file in block 415, notifying the second client of the change via second system 314 in block 416, and requesting authorization from the second client to edit the old e-mail address in the second database 315 within second system 314 to the new e-mail address in block 417.

For example, upon opening the e-mail message from the first client, the second client may open the attached file of the editing program. When open, the file may provide a brief notice to the second client of the first client's e-mail address update. This simply may be accomplished with a window stating information of the change. Moreover, the window may require the second client to confirm receipt of the notice by clicking a first icon. Then, the window may request authorization from the second client by requesting the second client to click a second icon.

Method 410 further includes receiving authorization from the second client to edit the old e-mail address in the second database 315 within second system 314 to the new e-mail address in block 418 and editing the old e-mail address in the second database 315 within second system 314 to the new e-mail address in block 420. Thus, the second client may provide authorization to configure the editing program accordingly within second system 314 by clicking the second icon. Upon receiving authorization from the second client, the editing program may be designed to open the editing file and access the inputted information. The program may then execute the information as parameters within which the program operates. In this embodiment, the editing program is configured to automatically update/change, within database 313 of second system 314, the first client's e-mail addresses identified as “old” to the “new” e-mail address. This simplifies management of the second client's e-mail address portfolio. This embodiment of the present invention allows the second client to automatically update database 313 without the typical inconveniences of manually typing in the information of the first client. Moreover, it is understood that e-mail software differs and that the editing program/file may be configured to convert and transfer information between differing software.

Moreover, it is to be noted that information other than email address portfolios may be implemented with the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of managing an update of an old email address to a new email address of a first client via a first system, the update being managed by a system for a second client, the method comprising:
providing inputted information of the update in the first system;
sending the inputted information from the first system to the second system via a communication network, the inputted information representing the update of the old and new email addresses and identification of the first client, the inputted information being recognizable by the second system;
configuring the information of the update into the second system to monitor outgoing email addresses of subsequent email messages;
sensing an outgoing email address of a subsequent email message sent from the second system; and
redirecting the subsequent email message to the new email address of the first client, if the outgoing email address is determined to be the old email address of the first client.

2. The method of claim 1 wherein providing inputted information includes providing an inputted monitoring program configured within the first and second systems, the monitoring program being capable of monitoring outgoing email addresses of subsequent email messages, the monitoring program having a monitoring file configured to receive the inputted information of the update.

3. The method of claim 2 wherein sending the inputted information includes sending the monitoring file having the inputted information.

4. The method of claim 3 further comprising:
notifying the second client via the second system of the update, after sending the monitoring file;
requesting authorization from the second client to configure the monitoring program within the second system with the new email address, after notifying the second client of the update;
receiving authorization from the second client to configure the monitoring program within the second system with the new email address; and
providing notification of the update of the outgoing email address to the second system prior to redirecting the subsequent email message, if the outgoing email address is determined to be the old email address of the first client.

5. The method of claim 4 further comprising recognizing the inputted information in the monitoring file.

6. The method of claim 5 further comprising determining whether the outgoing email address is the old email address of the first client.

7. The method of claim 3 wherein the communication network includes a local area network, a metropolitan area network, and a wide area network.

8. The method of claim 3 wherein the information of the update includes data indicative of the first client.

9. The method of claim 8 wherein the information includes the old email address of the first client, the new email address of the first client, identification of the first client, effective date of the update, and time period of the update.

10. The method of claim 4 further comprising confirming with the second client that the outgoing email address is the updated email address, after notifying the second client.

11. The method of claim 10 further comprising receiving authorization from the second client to redirect the subsequent email message to the new address when confirmation is given by the second client.

12. The method of claim 3 further comprising notifying the second client via the second system of the update.

13. The method of claim 3 wherein the subsequent email messages are sent from the second system.

14. The method of claim 3 wherein second system recognizes the information of the update.

15. The method of claim 3 wherein the subsequent email message is sent subsequent to sending the monitoring file.

16. The method of claim 3 wherein the first system includes a system of an Internet carrier, a system of a hard-drive for a central processing unit, a system of a local area network, a system of a metropolitan area network, and system of a wide area network.

17. The method of claim 3 wherein the second system includes a system of an Internet carrier, a system of a hard-drive for a central processing unit, a system of a local area network, a system of a metropolitan area network, and system of a wide area network.

18. A method of making a change in an email address of a first client via a first system, the change being made by a second system for a second client, the second system associated with an email address database, the method comprising:
providing an inputted editing program configured within the first and second systems to edit a change of an old email address to a new email address of the first client within the email address database containing the old email address of the first client;
sending from the first system an editing file of the editing program to the second system via a communication network, the editing file being configured to receive inputted information of the change, the editing file having inputted information representing the change of the old and new email addresses and identification of the first client, the information being recognizable by the second system;
notifying the second client of the change via the second system;
receiving authorization from the second client to edit the old email address in the email address database within the second system to the new email address; and
editing the old email address in the email address database within the second system to the new email address.

19. The method of claim 18 further comprising recognizing the inputted information in the sent monitoring file.

20. The method of claim 18 further comprising requesting authorization from the second client to edit the old email address in the email address database within the second system to the new email address.

21. The method of claim 18 wherein the communication network includes a local area network, a metropolitan area network, and a wide area network.

22. The method of claim 18 wherein the communication network is an Internet network.

23. The method of claim 18 wherein the information of the change includes data indicative of the first client.

24. The method of claim 23 wherein the information includes the old email address of the first client, the new email of the first client, identification of the first client, effective date of the change, and time period of the change.

25. The method of claim 18 wherein the first system includes a system of an Internet carrier, a system of a hard-drive for a central processing unit, a system of a local area network, a system of a metropolitan area network, and system of a wide area network.

26. The method of claim 18 wherein the second system includes a system of an Internet carrier, a system of a hard-drive for a central processing unit, a system of a local area network, a system of a metropolitan area network, and system of a wide area network.

27. A system for managing an update of an old email address to a new email address of a first client via a first system, the update being managed by a second system for a second client, the system comprising:
a first mechanism for providing an inputted monitoring program configured within the first and second systems, the monitoring program being capable of monitoring outgoing email addresses of subsequent email messages;
a second mechanism for sending from the first system a monitoring file of the monitoring program to the second system via a communication network, the monitoring file being configured to receive inputted information of the update, the monitoring file having inputted information representing the update of the old and new email addresses and identification of the first client, the information being recognizable by the second system;
a third mechanism for configuring the information of the update into the monitoring program within the second system to monitor outgoing email addresses of subsequent email messages;
a fourth mechanism for sensing an outgoing email address of a subsequent email message sent from the second system; and
a fifth mechanism for redirecting the subsequent email message to the new email address of the first client, if the outgoing email address is determined to be the old email address of the first client.

28. A system for making a change in an email address of a first client via a first system, the change being made by a second system for a second client, the second system associated with an email address database, the system comprising:
a first mechanism for providing an inputted editing program configured within the first and second systems to edit a change of an old email address to a new email address of the first client within the email address database containing the old email address of the first client;
a second mechanism for sending from the first system an editing file of the editing program to the second system via a communication network, the editing file being configured to receive inputted information of the change, the editing file having inputted information representing the change of the old and new email addresses and identification of the first client, the information being recognizable by the second system;
a third mechanism for notifying the second client of the change via the second system;
a fourth mechanism for receiving authorization from the second client to edit the old email address in the email address database within the second system to the new email address; and
a fifth mechanism for editing the old email address in the email address database within the second system to the new email address.
